(19) United States
(12) Patent Application Publication
(10) Pub. No.: US 2010/0198816 A1
(43) Pub. Date: Aug. 5, 2010

(54) SYSTEM AND METHOD FOR PRESENTING CONTENT REPRESENTATIVE OF DOCUMENT SEARCH

(75) Inventor: Remi Kwan, Montreal (CA)

Correspondence Address: HICKMAN PALERMO TRUONG & BECKER LLP/Yahoo! Inc., 2055 Gateway Place, Suite 550, San Jose, CA, 95110-1083, US

(73) Assignee: YAHOO! INC., Sunnyvale, CA (US)

(21) Appl. No.: 12/362,896

(22) Filed: Jan. 30, 2009

(51) Int. Cl. G06F 7/06; G06F 17/30

(52) U.S. Cl. 707/723; 707/E17.108

(57) ABSTRACT

A system and method for selecting content that is representative of one or more documents is provided. Aspects provide for a fully automated machine-learned system that does not require costly manual selection and supervision of content. The system enables search engines to leverage existing news feeds and content bases to generate a more compelling presentation of search engine results.

### BACKGROUND

1. Field of the Invention

Aspects in accord with the present invention relate generally to systems and methods for summarizing documents, and more specifically, to methods and systems for augmenting the presentation of a document with secondary content relevant to the subject of the document.

2. Discussion of Related Art

There are a variety of tools and techniques for summarizing large quantities of information into concise units. One such tool, which resides within the context of the internet, is the search engine. Internet search engines, such as the YAHOO! brand search engine, typically provide concise summaries of documents in response to queries that are submitted to the search engine by a user.

More specifically, conventional internet search engines allow users to search for documents by submitting textual queries including one or more keywords. Normally, search engines parse submitted queries and find result documents that prominently feature the keywords included in the query. Search engines then present concise summaries of the result documents to the user for review and selection. These summaries usually consist of any keywords found within the document, presented within a brief document context.

### SUMMARY OF THE INVENTION

Some aspects in accord with the present invention provide for a system with facilities that select content representative of documents subjects. For example, some embodiments select one or more elements of content, such as images, that are representative of topical documents, such as news stories. In at least one embodiment, the selected images are presented in association with the news stories within the context of a set of search engine results. In this way, aspects and embodiments provide search engine users with a richer search experience and more easily understood results.

According to one embodiment, a method for presenting search results is provided. The method includes acts of receiving query information from an external entity, determining first search results based at least in part on the query information, the first search results including document information relating to documents, the document information including content information referencing associated content that is associated with the documents and scoring the relevancy of the associated content relative to the documents to produce first scored content, the act of scoring being based at least in part on the query information and the first search results.

According to one example, the act of receiving the query may include an act of receiving the query from a user. In another example, the act of determining first search results may include an act of determining first search results using a vertical search engine. In an additional example, the act of scoring the content may include an act of scoring the content using a parametric scoring function. Furthermore, according to another example, the act of scoring the content may include an act of scoring the content using a trained statistical model.

According to another example, the method may also include acts of determining second search results based at least in part on the query information and the first search results, the second search results including content information referencing unassociated content that is not associated with documents and scoring the relevancy of the unassociated content relative to the documents to produce second scored content, the act of scoring being based at least in part on the query information, the first search results and the second search results. In one example, the act of determining the second search results may include an act of determining second search results using a content search engine.

In another example, the method may also include acts of selecting display content from the first scored content and the second scored content based at least in part on the score of the first scored content and the score of the second scored content and providing the display content in association with the documents. In an example, the act of selecting display content may include an act of selecting display content based at least in part on a parametric function. In another example, the act of selecting display content may include an act of selecting display content based at least in part on a trained statistical model.

According to another embodiment, a system for presenting search results is provided. The system includes a network interface, a storage medium and a controller coupled to the network interface and the storage medium and configured to receive query information from an external entity, determine first search results based at least in part on the query information, the first search results including document information relating to documents, the document information including content information referencing associated content that is associated with the documents and score the relevancy of the associated content relative to the documents to produce first scored content, the act of scoring being based at least in part on the query information and the first search results.

In one example, the controller may be further configured to receiving the query from a user through a user interface. In another example, the controller may be further configured to determine first search results using a vertical search engine. In yet another example, the controller may be further configured to score the content using a parametric scoring function. In an additional example, the controller may be further configured to score the content using a trained statistical model. According to another example, the controller is further configured to determine second search results based at least in part on the query information and the first search results, the second search results including content information referencing unassociated content that is not associated with documents and score the relevancy of the unassociated content relative to the documents to produce second scored content, the act of scoring being based at least in part on the query information, the first search results and the second search results. In further example, the controller may be further configured to determine second search results using a content search engine. In yet another example, the controller is further configured to select display content from the first scored content and the second scored content based at least in part on the score of the first scored content and the score of the second scored content and provide the display content in association with the documents. In still another example, the controller may be further configured to select display content based at least in part on a parametric function. Furthermore, in an example, the controller may be further configured to select display content based at least in part on a trained statistical model. In another example, the controller may be further configured to determine appropriate content within the first scored content and the second scored content and select display content from the appropriate content based at least in part on the score of the appropriate content.

Still other aspects, embodiments, and advantages of these exemplary aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. The accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates an example computer system upon which various aspects in accord with the present invention may be implemented;

FIG. 2 depicts an example content aware search engine in the context of a distributed system according to an embodiment;

FIG. 3 shows an example physical and logical diagram of a content aware search engine according to an embodiment;

FIG. 4 illustrates an example process for providing content in association with search results according to an embodiment;

FIG. 5 depicts an example process for receiving a query according to an embodiment;

FIG. 6 shows an example process for determining search results according to an embodiment;

FIG. 7 illustrates an example process for scoring content according to an embodiment; and

FIG. 8 depicts an example process for providing content in association with search results according to an embodiment.

### DETAILED DESCRIPTION

At least one embodiment in accord with the present invention relates to a system with facilities, i.e. executable code and data structures, configured to score content with regard to its relevancy to one or more documents included in a set of search engine results. Documents may include any information that is conveyable via a computer system. Thus documents include a wide variety of information including, among others, HTML documents, text documents, multi-media content, images, sound recordings and executable content. Additionally, according to an embodiment, the system can select content based on its relevancy to the subject of each document included in the search engine results. Further, according to an embodiment, the system includes facilities configured to provide selected content in association with internet search engine results.

The aspects disclosed herein, which are in accord with the present invention, are not limited in their application to the details of construction and the arrangement of components set forth in the following description or illustrated in the drawings. These aspects are capable of assuming other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments.

For example, according to various embodiments of the present invention, a computer system is configured to perform any of the functions described herein, including but not limited to, scoring the relevancy of content in relation to documents. However, such a system may also perform other functions. Moreover, the systems described herein may be configured to include or exclude any of the functions discussed herein. Thus the invention is not limited to a specific function or set of functions. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items.

### Computer System

Various aspects and functions described herein in accord with the present invention may be implemented as hardware or software on one or more computer systems. There are many examples of computer systems currently in use. Some examples include, among others, network appliances, personal computers, workstations, mainframes, networked clients, servers, media servers, application servers, database servers and web servers. Other examples of computer systems may include mobile computing devices, such as cellular phones and personal digital assistants, and network equipment, such as load balancers, routers and switches. Additionally, aspects in accord with the present invention may be located on a single computer system or may be distributed among a plurality of computer systems connected to one or more communication networks.

For example, various aspects and functions may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Thus, the invention is not limited to executing on any particular system or group of systems. Further, aspects may be implemented in software, hardware or firmware, or any combination thereof. Thus, aspects in accord with the present invention may be implemented within methods, acts, systems, system elements and components using a variety of hardware and software configurations, and the invention is not limited to any particular distributed architecture, network, or communication protocol.

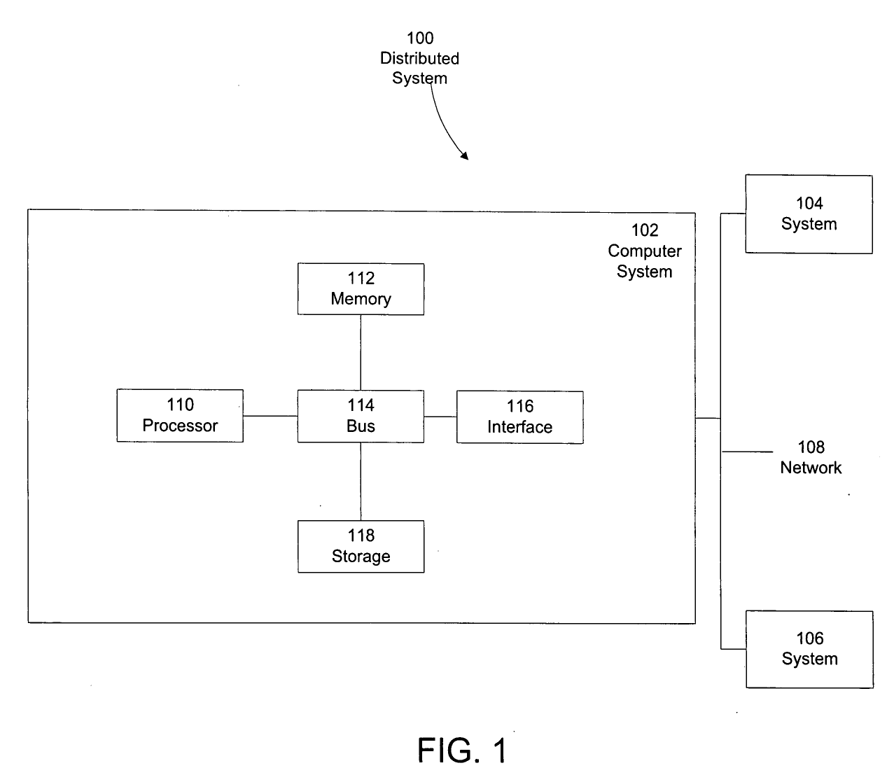

FIG. 1 shows a block diagram of a distributed computer system 100, in which various aspects and functions in accord with the present invention may be practiced. The distributed computer system 100 may include one more computer systems. For example, as illustrated, the distributed computer system 100 includes three computer systems 102, 104 and 106. As shown, the computer systems 102, 104 and 106 are interconnected by, and may exchange data through, a communication network 108. The network 108 may include any communication network through which computer systems may exchange data. To exchange data via the network 108, the computer systems 102, 104 and 106 and the network 108 may use various methods, protocols and standards including, among others, token ring, Ethernet, Wireless Ethernet, Bluetooth, TCP/IP, UDP, HTTP, FTP, SNMP, SMS, MMS, SS7, JSON, XML, REST, SOAP, CORBA IIOP, RMI, DCOM and Web Services. To ensure data transfer is secure, the computer systems 102, 104 and 106 may transmit data via the network 108 using a variety of security measures including TSL, SSL or VPN, among other security techniques. While the distributed computer system 100 illustrates three networked computer systems, the distributed computer system 100 may include any number of computer systems, networked using any medium and communication protocol.

Various aspects and functions in accord with the present invention may be implemented as specialized hardware or software executing in one or more computer systems including a computer system 102 shown in FIG. 1. As depicted, the computer system 102 includes a processor 110, a memory 112, a bus 114, an interface 116 and a storage system 118. The processor 110, which may include one or more microprocessors or other types of controllers, can perform a series of instructions that result in manipulated data. The processor 110 may be a commercially available processor such as an Intel Pentium, Motorola PowerPC, SGI MIPS, Sun UltraSPARC, or Hewlett-Packard PA-RISC processor, but may be any type of processor or controller as many other processors and controllers are available. As shown, the processor 110 is connected to other system elements, including a memory 112, by the bus 114.

The memory 112 may be used for storing programs and data during operation of the computer system 102. Thus, the memory 112 may be a relatively high performance, volatile, random access memory such as a dynamic random access memory (DRAM) or static memory (SRAM). However, the memory 112 may include any device for storing data, such as a disk drive or other non-volatile storage device. Various embodiments in accord with the present invention can organize the memory 112 into particularized and, in some cases, unique structures to perform the aspects and functions disclosed herein.

Components of the computer system 102 may be coupled by an interconnection element such as the bus 114. The bus 114 may include one or more physical busses (for example, busses between components that are integrated within a same machine), but may include any communication coupling between system elements including specialized or standard computing bus technologies such as IDE, SCSI, PCI and InfiniBand. Thus, the bus 114 enables communications (for example, data and instructions) to be exchanged between system components of the computer system 102.

The computer system 102 also includes one or more interface devices 116 such as input devices, output devices and combination input/output devices. The interface devices 116 may receive input or provide output. More particularly, output devices may render information for external presentation. Input devices may accept information from external sources. Examples of interface devices include, among others, keyboards, mouse devices, trackballs, microphones, touch screens, printing devices, display screens, speakers, network interface cards, etc. The interface devices 116 allow the computer system 102 to exchange information and communicate with external entities, such as users and other systems.

The storage system 118 may include a computer readable and writeable nonvolatile storage medium in which instructions are stored that define a program to be executed by the processor. The storage system 118 also may include information that is recorded, on or in, the medium, and this information may be processed by the program. More specifically, the information may be stored in one or more data structures specifically configured to conserve storage space or increase data exchange performance. The instructions may be persistently stored as encoded signals, and the instructions may cause a processor to perform any of the functions described herein. The medium may, for example, be optical disk, magnetic disk or flash memory, among others. In operation, the processor 110 or some other controller may cause data to be read from the nonvolatile recording medium into another memory, such as the memory 112, that allows for faster access to the information by the processor than does the storage medium included in the storage system 118. The memory may be located in the storage system 118 or in the memory 112. The processor 110 may manipulate the data within the memory 112, and then copy the data to the medium associated with the storage system 118 after processing is completed. A variety of components may manage data movement between the medium and integrated circuit memory element and the invention is not limited thereto. Further, the invention is not limited to a particular memory system or storage system.

Although the computer system 102 is shown by way of example as one type of computer system upon which various aspects and functions in accord with the present invention may be practiced, aspects of the invention are not limited to being implemented on the computer system as shown in FIG. 1. Various aspects and functions in accord with the present invention may be practiced on one or more computers having a different architectures or components than that shown in FIG. 1. For instance, the computer system 102 may include specially-programmed, special-purpose hardware, such as for example, an application-specific integrated circuit (ASIC) tailored to perform a particular operation disclosed herein. While another embodiment may perform the same function using several general-purpose computing devices running MAC OS System X with Motorola PowerPC processors and several specialized computing devices running proprietary hardware and operating systems.

The computer system 102 may include an operating system that manages at least a portion of the hardware elements included in computer system 102. A processor or controller, such as processor 110, may execute an operating system which may be, among others, a Windows-based operating system (for example, Windows NT, Windows 2000 (Windows ME), Windows XP, or Windows Vista) available from the Microsoft Corporation, a MAC OS System X operating system available from Apple Computer, one of many Linux-based operating system distributions (for example, the Enterprise Linux operating system available from Red Hat Inc.), a Solaris operating system available from Sun Microsystems, or a UNIX operating systems available from various sources. Many other operating systems may be used, and embodiments are not limited to any particular operating system.

The processor and operating system together define a computing platform for which application programs in high-level programming languages may be written. These component applications may be executable, intermediate (for example, C# or JAVA bytecode) or interpreted code which communicate over a communication network (for example, the Internet) using a communication protocol (for example, TCP/IP). Similarly, aspects in accord with the present invention may be implemented using an object-oriented programming language, such as SmallTalk, JAVA, C++, Ada, or C# (C-Sharp). Other object-oriented programming languages may also be used. Alternatively, procedural, scripting, or logical programming languages may be used.

Additionally, various aspects and functions in accord with the present invention may be implemented in a non-programmed environment (for example, documents created in HTML, XML or other format that, when viewed in a window of a browser program, render aspects of a graphical-user interface or perform other functions). Further, various embodiments in accord with the present invention may be implemented as programmed or non-programmed elements, or any combination thereof. For example, a web page may be implemented using HTML while a data object called from within the web page may be written in C++. Thus, the invention is not limited to a specific programming language and any suitable programming language could also be used.

A computer system included within an embodiment may perform functions outside the scope of the invention. For instance, aspects of the system may be implemented using an existing commercial product, such as, for example, Database Management Systems such as SQL Server available from Microsoft of Seattle, Wash., Oracle Database from Oracle of Redwood Shores, Calif., and MySQL from Sun Microsystems of Santa Clara, Calif. or integration software such as WebSphere middleware from IBM of Armonk, N.Y. However, a computer system running, for example, SQL Server may be able to support both aspects in accord with the present invention and databases for sundry applications not within the scope of the invention.

### Example System Architecture

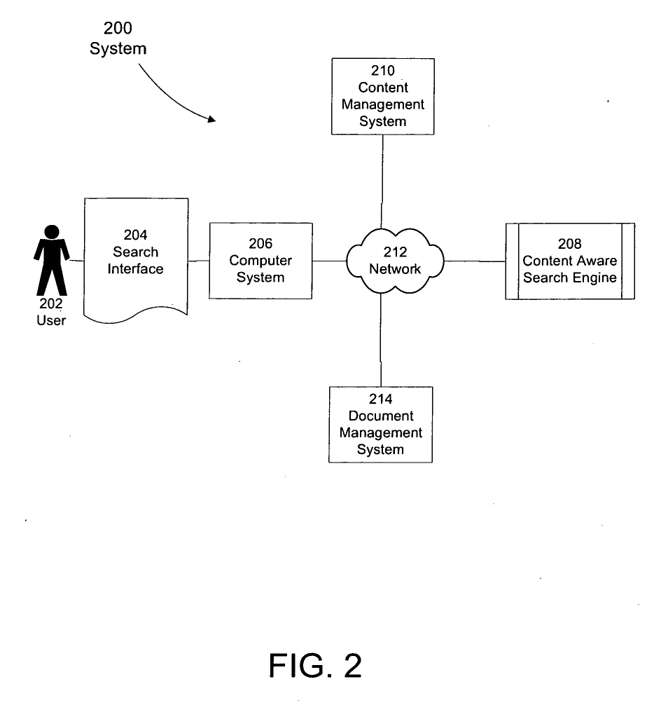

FIG. 2 presents a context diagram of a distributed system 200 specially configured to include an embodiment in accord of the present invention. Referring to FIG. 2, the system 200 includes a user 202, a search interface 204, a computer system 206, a content aware search engine 208, a content management system 210, a communications network 212 and a document management system 214. In the embodiment shown, the search interface 204 is a browser-based user interface served by the content aware search engine 208 and rendered by the computer system 206. In this illustration, the computer system 206, the content aware search engine 208, the content management system 210 and the document management system 214 are interconnected via the network 212. The network 212 may include any communication network through which member computer systems may exchange data. For example, the network 212 may be a public network, such as the internet, and may include other public or private networks such as LANs, WANs, extranets and intranets.

The sundry computer systems shown in FIG. 2, which include the computer system 206, the content aware search engine 208, the content management system 210, the network 212 and the document management system 214 each may include one or more computer systems. As discussed above with regard to FIG. 1, computer systems may have one or more processors or controllers, memory and interface devices. The particular configuration of system 200 depicted in FIG. 2 is used for illustration purposes only and embodiments of the invention may be practiced in other contexts. Thus, the invention is not limited to a specific number of users or systems.

In various embodiments, the content aware search engine 208 includes facilities configured to provide search results to users. In the illustrated embodiment, the content aware search engine 208 can provide the search interface 204 to the user 202. The search interface 204 may include facilities configured to allow the user 202 to search, select and review a variety of content. For example, in one embodiment, the search interface 204 can provide, within a set of search results, navigable links to documents available from a wide variety of websites connected to the network 212. In other embodiments, the search interface 204 can provide links stored in the content aware search engine 208.

In another embodiment, the content aware search engine 208 includes facilities configured to receive documents from the document management system 214. These documents may cover a variety of topics. For example, in one embodiment directed toward current events, the document management system 214 includes a news feed provided by various news agencies, such as Reuters and the Associated Press, and the documents include news articles.

According to another embodiment, the search interface 204 also includes facilities configured to present additional content in association with the document links included in search results. The additional content may be any information conveyable via a computer system that is representative of the subject of the linked documents. For example, in one embodiment, the search interface 204 can provide images, or other content, that portray the subject of one or more linked documents from the content management system 210. In another embodiment, the search interface 204 can provide multi-media presentations, such as movie clips or outtakes, that represent the subject of the linked document.

In various embodiments, the content aware search engine 208 includes facilities configured to receive the additional content from a variety of sources. For example, the content aware search engine 208 may receive the additional content from the content management system 210 and the document management system 214. In at least one embodiment, the content aware search engine 208 can store the additional content internally.

In an embodiment directed toward current events, the document management system 214 includes a news feed with news articles and associated images. In another embodiment, the content management system 210 includes a feed of content information not associated with document information. This unassociated content information may include or reference images, videos or audio of current events. In other embodiments, the content management system 210 provides additional content including, among other content, company logos, images of businesses, images of hotels, and multi-media advertisements for resorts.

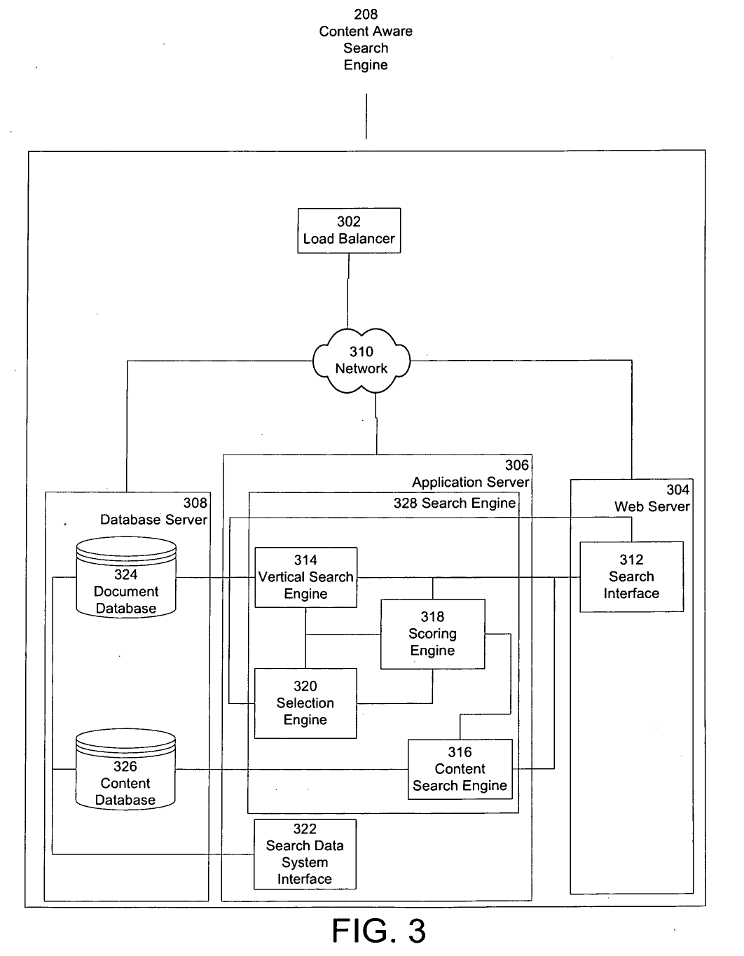

FIG. 3 provides a more detailed illustration of a particular physical and logical configuration of the content aware search engine 208 as a distributed system. The system structure and content discussed below are for exemplary purposes only and are not intended to limit the invention to the specific structure shown in FIG. 3. As will be apparent to one of ordinary skill in the art, many variant system structures can be architected without deviating from the scope of the present invention. The particular arrangement presented in FIG. 3 was chosen to promote clarity.

In the embodiment illustrated in FIG. 3, the content aware search engine 208 includes five primary physical elements: a load balancer 302, a web server 304, an application server 306, a database server 308 and a network 310. Each of these physical elements may include one or more computer systems as discussed with reference to FIG. 1 above. Further, in the illustrated embodiment, the web server 304 includes one logical element, a search interface 312. The application server 306 includes two logical elements: a search engine 328 and a search data system interface 322. The search engine 328 has facilities configured to manage the flow of information between constituent subsystems and includes a vertical search engine 314, a content search engine 316, a scoring engine 318 and a selection engine 320. The database server 308 includes two logical elements: a document database 324 and a content database 326.

In the depicted embodiment, the load balancer 302 provides load balancing services to the other elements of the content aware search engine 208. The network 310 may include any communication network through which member computer systems may exchange data. The web server 304, the application server 306 and the database server 308 may be, for example, one or more computer systems as described above with regard to FIG. 1. For a high volume website, web server 304, application server 306 and database server 308 may include multiple computer systems, but embodiments may include any number of computer systems. Web server 304 may serve content using any suitable standard or protocol including, among others, HTTP, HTML, DHTML, XML and PHP.

In the embodiment illustrated in FIG. 3, the logical elements include facilities that are configured to exchange information as follows. The search interface 312 includes facilities configured to receive query information from, and provide search results to, various external entities, such as a user or an external system. Additionally, the search interface 312 can provide query information to the vertical search engine 314, the content search engine 316, the scoring engine 318 and the selection engine 320. Also, in this embodiment, the search interface 312 can receive search results from the selection engine 320.

As shown in the embodiment of FIG. 3, the vertical search engine 314 has facilities configured to receive query information from the search interface 312 and document information from the document database 324. Moreover, the vertical search engine can provide document information to the scoring engine 318 and the selection engine 320. Furthermore, as depicted, the content search engine 316 has facilities configured to receive query information from the search interface 312 and content information from the content database 326. In addition, according to this embodiment, the content search engine 316 can provide content information to the scoring engine 318.

Further according to the embodiment of FIG. 3, the scoring engine 318 has facilities configured to receive query information from the search interface 312, document information from the vertical search engine 314 and content information from the content search engine 316. As illustrated, the scoring engine 318 can provide content information, such as scored content information, to the selection engine 320. As shown, the selection engine 320 has facilities configured to receive content information from the scoring engine, document information from the vertical search engine 314 and query information from the search interface 312 and to provide search results to the search interface 312. Additionally, the search data system interface 322 can receive content and document information from a variety of external entities and can provide the content information to the content database 326 and the document information to the document database 324.

Information may flow between the elements, components and subsystems described herein using any technique. Such techniques include, for example, passing the information over the network via TCP/IP, passing the information between modules in memory and passing the information by writing to a file, database, or some other non-volatile storage device. In addition, pointers or other references to information may be transmitted and received in place of, or in addition to, copies of the information. Conversely, the information may be exchanged in place of, or in addition to, pointers or other references to the information. Other techniques and protocols for communicating information may be used without departing from the scope of the invention.

With continued reference to the embodiment of FIG. 3, the document database 324 includes facilities configured to store and retrieve document information. Document information may include any information related to documents that are available for review by a user of a computer system. Thus, the documents related to the document information may be stored within the document database 324, or may be available for review over a network, such as the internet. Examples of document information include, among others, the content contained within the document and metadata describing a document such as document versions, document sizes, document edit histories, available translations of the document, document storage locations, textual titles or other identifiers of the document, classification information, such as tags, that classify the document and descriptive content, such as an text abstract of the document. Document information may also include additional content information and associations between the additional content information and one or more documents. In one embodiment, this additional content information includes, among other content, abstracts, images and multi-media presentations.

According to the illustrated embodiment, the content database 326 includes structures configured to store and retrieve content information. Content information may include or reference any information regarding content that is conveyable via a computer system. Examples of content information include, among others, the content and metadata describing the content such as content versions, content sizes, content edit histories, available translations of the content, content storage locations, textual title or other identifiers of the content, information descriptive of the content, such as an textual abstract, and classification information, such as tags, that classify the content. In certain embodiments, the content included in the content information may be, among other information, executable content or non-executable content, such as still images, movies, audio, and text.

The databases 324 and 326 may take the form of any logical construction capable of storing information on a computer readable medium including flat files, indexed files, hierarchical databases, relational databases or object oriented databases. In addition, links, pointers, indicators and other references to data may be stored in place, of or in addition to, actual copies of the data. The data may be modeled using unique and foreign key relationships and indexes. The unique and foreign key relationships and indexes may be established between the various fields and tables to ensure both data integrity and data interchange performance.

With continued reference to the embodiment of FIG. 3, the search data system interface 322 has facilities configured to receive search data from a variety of external entities and to provide the search data to the document database 324 and the content database 326 for storage. For example, according to one embodiment, the search data system interface 322 can receive document information or content information from a web crawler. In this embodiment, the search data system interface 322 can provide the received information to the document database 324 or the content database 326, as appropriate.

In another exemplary embodiment, the search data system interface 322 can receive information from one or more automated information feeds and can provide the received information to the document database 324 and the content database 326 for storage. The information received from the feeds may include document information such as news articles, and additional content information that is associated with the document information. The document information may indicate that associations between the news articles and the additional content information were established by a user, such as an editor.

In other embodiments, the search data system interface 322 can receive unassociated content information. In these embodiments, the search data system interface 322 can provide the content information to the content database 326 for storage. This content information may include or reference a variety of content, such as, among other content, images of current events, images and logos of businesses and multi-media presentations for hotels, resorts and other travel destinations.

With continued reference to the embodiment of FIG. 3, the vertical search engine 314 has facilities configured to retrieve document information that matches query information. The query information may include any information related to one or more queries for information entered by an external entity. For example, in one embodiment, the vertical search engine 314 can receive a set of textual keywords provided by a user through the search interface 312. The document information may include any document information discussed above with regard to the document database 324. Thus, in one example, the document information may include references, such as hyperlinks, to documents that are stored in the document database 324. In another example, the document information may include hyperlinks to documents that are stored in an external system, such as one or more websites accessible via the internet. In still another example, the document information may include content information associated with the document information, i.e. content information referencing content that is associated with documents related to the document information. As shown in the embodiment of FIG. 3, the vertical search engine 314 can provide this document information to the scoring engine 318.

In some embodiments, the vertical search engine 314 includes facilities configured to search within one or more vertical search classes. In this manner, embodiments can provide searching facilities that focus on the specific groups of content defined by the vertical search classes. For example, according to an embodiment directed toward current events, the vertical search engine 314 can perform searches specifically targeting news article documents. Other embodiments focus on other vertical search classes, such as images, movies, video gaming, local businesses and travel.

In another embodiment, the content search engine 316 includes facilities configured to retrieve content information that may be representative of, or relevant to, the subjects of documents matching the query information. As discussed above, the query information may include a set of textual keywords provided by a user through the search interface 312. The content information may include any content information discussed above with regard to the content database 326. Thus, in one example, the content information may include content, or a reference to content, stored in the content database 326. In an additional example, the content information may include a reference to content stored in an external system, such as one or more websites accessible via the internet. In the embodiment of FIG. 3, the content search engine 316 can provide this content information to the scoring engine 318.

Like the vertical search engine 314, in some embodiments, the content search engine 316 includes facilities configured to search within one or more vertical search classes. For example, according to an embodiment directed toward current events, the content search engine 316 can perform searches specifically targeting content related to current events. Other embodiments focus on other vertical search classes, such as images, movies, video gaming, local businesses and travel.

With continued reference to the embodiment of FIG. 3, the scoring engine 318 includes facilities configured to score the relevancy of the content information provided by the content search engine 316 and the vertical search engine 314 relative to the documents matching the query information provided by the search interface 312. Various embodiments employ a variety of functions to compute this relevancy score. Some embodiments use a heuristic or parametric function based on the query information, the document information and the content information. Other embodiments use a statistical model based on the query information, the document information and the content information.

For example, according to one embodiment, the scoring engine 318 can use the text included in the query information, the text included in the document information, such as titles, abstracts, tags, document content, etc., and the text included in the content information, such as titles, abstracts, tags, textual content, etc. to compute the relevancy score. In this embodiment, the scoring function is configured to produce a higher score when the text included in the content information better matches either the query text or the text included in the document information. Thus, when dealing with large amounts of document and content information, the scoring function of this embodiment will minimize the likelihood of scoring irrelevant content highly.

In another embodiment, the scoring engine 318 has facilities configured to utilize a scoring function employing vector-based retrieval methods. In this embodiment, the scoring engine 318 can generate a bag-of-words vector for the document information from the words of the text included in the document information. According to this embodiment, the vector for the document information includes ordered pairs of words and associated weights which indicate the importance of the words when computing the relevancy score.

More specifically, in one embodiment, the scoring engine 318 can construct the vector for the document information by adding an entry in the vector with a first weight for each non-entity term that appears in the text included in the document information and by adding an entry in the vector with a second weight for each entity term that appears in the text included in the document information. In one example, the first weight may be less than the second weight.

Moreover, in some embodiments, the scoring engine 318 can identify entity terms, such as proper nouns, by using a part-of-speech indicator (tagger) that is specific to the language syntax being parsed by the scoring engine 318. For instance, in an embodiment directed toward the English language, the scoring engine 318 can scan editorially generated news articles using heuristics that classify any word beginning with an uppercase character as being an entity term and any word beginning with a lowercase character as being a non-entity term. This embodiment may be particularly well suited for processing news articles because news articles tend to adhere to well established stylistic guidelines regarding syntax. In other embodiments, the part-of-speech tagger may be a statistically trained hidden Markov model or a conditional random field model. In still another embodiment, the scoring engine 318 can consult a dictionary of entity terms when classifying words into entity and non-entity terms.

Further, according to an embodiment, the scoring engine 318 can also construct a bag-of-words vector for each element of content associated with the content information based on the text included in the content information. In addition, according to this embodiment, the scoring function is configured to determine a relevancy score for each element of content by comparing the bag-of-words vector of the document information to the bag-of words vector of the element of content using a distance metric, such as cosine distance. In alternative embodiments, word weight can be determined using tf-idf or other standard information retrieval weightings known in the art, and the scope of the invention is not limited to any particular word weighting methodology.

In other embodiments, the scoring engine 318 includes facilities configured to use a scoring function in the form of a statistical model. For example, in some embodiments, the scoring engine 318 can train the scoring function using machine learning techniques. In one such embodiment, the scoring function is configured to be trained against supervised judgments of appropriate and inappropriate content information. In addition, according to this embodiment, the scoring function can be trained to discriminate based on sundry characteristics. Examples of these characteristics include query text, text included in the document information and the content information, matches between the query text, the text included in the document information and the content information, whether an association between the content information and the document information exists, the age of the content, the identity of feed source and the vector-based score described above. In an additional embodiment, the scoring function can be trained using other attributes of the content, such as the size or duration of the content and the complexity included in the content, such as the distribution of colors in an image. Thus embodiments of the scoring engine 318 may discern content that is suitable for displays with limited resources using a wide variety of criteria.

In another embodiment, the scoring engine 318 includes a scoring function that is configured using an unsupervised machine learning technique. For example, in one such embodiment, the scoring function is a statistical language model that generates the probability of an occurrence of a particular set of words. In this embodiment, the scoring engine 318 can build the scoring function by counting the number of occurrences of each word in the document information and calculating the probability of occurrence of each word. In this embodiment, the scoring engine 318 scores content by generating the probability of the occurrence of the text included in the content information using the scoring function.

According to another embodiment, the scoring engine 318 has facilities configured to tailor scoring of content information that is included with, and associated with, document information. In this embodiment, the scoring engine 318 can compensate for a built-in bias for content information that is associated with document information using a discounting parameter. The discounting parameter may include a number between about 0 and 1, although this is not a requirement and the discounting parameter may take other forms and values, such as a number greater than 1. In this embodiment, the scoring engine 318 can adjust for any unwanted bias in favor of the content information associated with document information by multiplying the score of the content information by the discounting parameter.

With continued reference to the embodiment of FIG. 3, the selection engine 320 includes facilities configured to determine content to include in search results. Some embodiments including the selection engine 320 can make this determination using a heuristic or parametric function based on the scores of the content information and a threshold value. For example, in one embodiment, the selection engine 320 can include any content with a score equaling or exceeding the threshold value in the search results. In other embodiments, the selection engine 320 is configured to use a statistical model that discriminates based on a variety of traits. These traits may include, among other traits, the number documents within the document information that have associated additional content information, the number of elements of content scoring above a threshold value or whether the query information indicates an intent to retrieve certain types of content, for example, the query information indicates query rewrites with the word “photos” added, etc.

In additional embodiments, the selection engine 320 has facilities configured to dissolve existing associations between documents and content. For example, in one embodiment, the selection engine 320 can dissolve an association between content and a document if the selection engine determines that the content is not appropriate. As depicted in the embodiment of FIG. 3, the selection engine 320 can provide the search results including the content and document information to the search interface 312.

With reference to the embodiment shown in FIG. 3, the search interface 312 includes facilities configured to provide a variety of graphical user interface (GUI) metaphors designed to allow an external entity, such as a user, to search for content, navigate search results, select documents to review and review documents. For example, in some embodiments, the search interface 312 includes GUI elements to enable a user to enter one or more textual keyword queries that are collaboratively processed with the search engine 328. In a particular embodiment, these GUI elements include a text box and a query actuation element, such as a button.

In another embodiment, the search interface 312 has facilities configured to store and provide query information to the vertical search engine 314, the content search engine 316 and the scoring engine 318. This query information may be any information related to current or previous queries entered by an external entity. Examples of query information included, among others, the text of the query, previous queries entered by a user and an indicator of the external entity that entered the query.

In other embodiments, the search interface 312 has facilities configured to provide one or more navigable links to documents included in a set of search results to an external entity. As discussed above, the search results may include both document and content information. According to one embodiment, the search interface 312 can receive document and content information from the selection engine 320 and can provide the documents any associated content referenced in the document and content information to various external entities.

The configuration of various embodiments may be tailored to the needs of a variety of users. For example, in one embodiment, the search interface 312 includes facilities configured to provide the documents and any associated content to a search engine user who is simply searching for news content. In another embodiment, the search interface 312 has facilities configured to provide the documents and associated content to a content editor.

In this embodiment, the search interface 312 can receive an indication, for example, via a checkbox control, of acceptance or rejection of the association between the documents and the content. Further, according to this embodiment, the search interface 312 includes facilities configured to store the documents, content and associations in the document database 324 and the content database 326, as appropriate. In some embodiments, the information entered by the content editor can directly influence the content information is associated with particular documents. For example, in one embodiment, the information entered by the content editor can override the recommendations of the scoring engine 318. In other embodiments, the information entered by the content editor can be used by the scoring engine 318 to train scoring functions. For example, in one embodiment, the acceptance or rejection of an association by the content editor can be used as a supervised judgment of appropriate and inappropriate content information by the scoring engine 318. In this way, embodiments enable search engine operators to increase the likelihood that content associated with documents is relevant.

Each of the interfaces disclosed herein exchange information with various providers and consumers. These providers and consumers may include any external entity including, among other entities, users and systems. In addition, each of the interfaces disclosed herein may both restrict input to a predefined set of values and validate any information entered prior to using the information or providing the information to other components. Additionally, each of the interfaces disclosed herein may validate the identity of an external entity prior to, or during, interaction with the external entity. These functions may prevent the introduction of erroneous data into the system or unauthorized access to the system.

### Content Presentation Processes

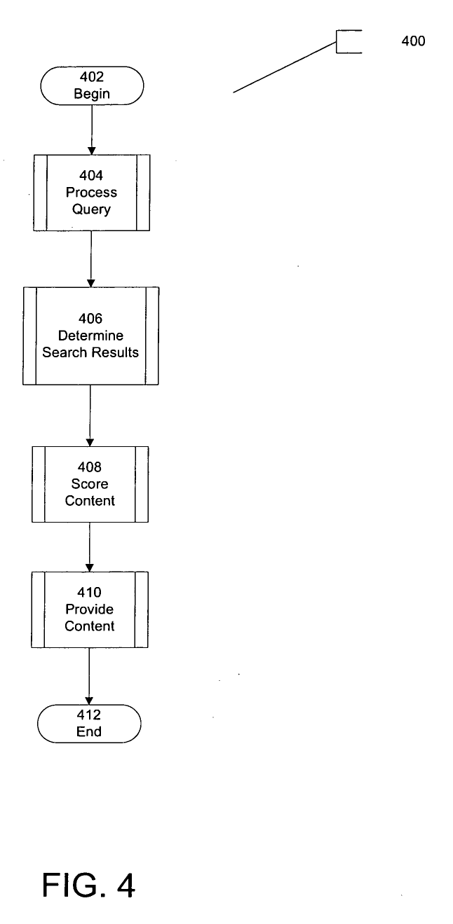

Various embodiments provide processes for presenting documents in association with content that is representative the documents. FIG. 4 illustrates one such process 400 that includes acts of processing a query, determining search results, scoring content relevancy and provide the content in association with documents. Process 400 begins at 402.

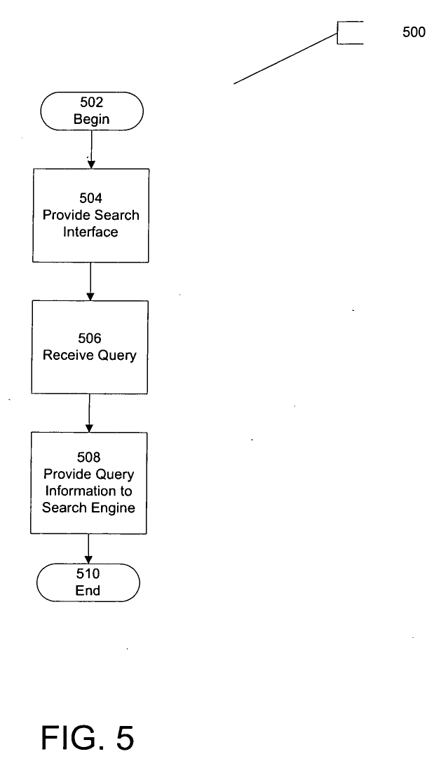

In act 404, a query is processed. According various embodiments, a computer system receives and processes a query. Acts in accord with these embodiments are discussed below with reference to FIG. 5.

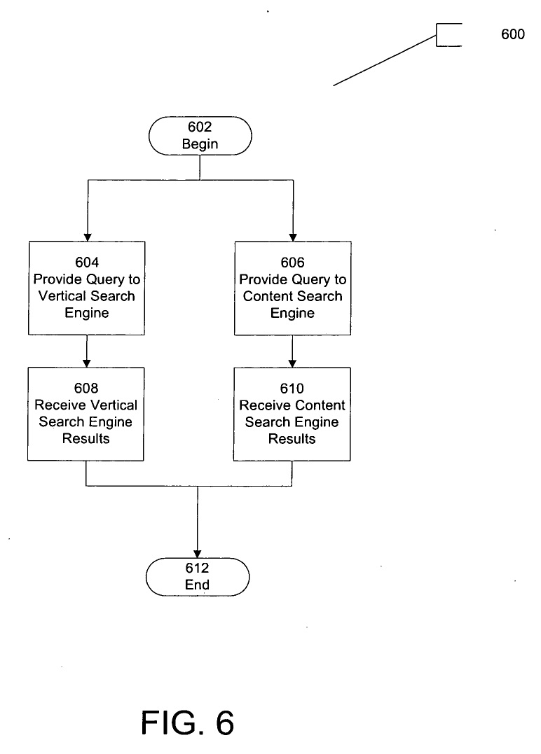

In act 406, search results are determined. According a variety embodiments, a computer system determines document and content search results based on query information. Acts in accord with these embodiments are discussed below with reference to FIG. 6.

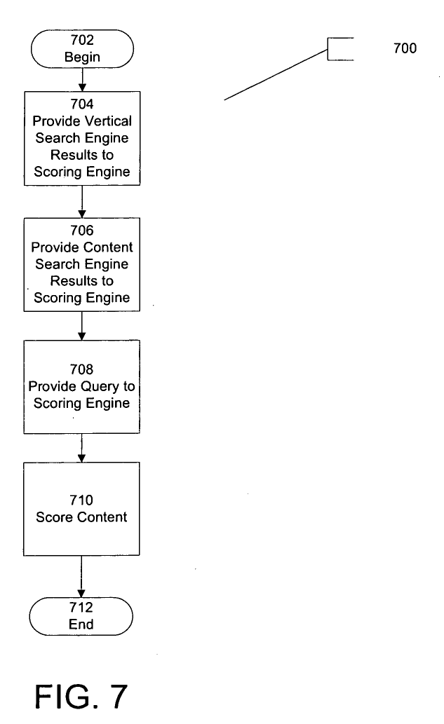

In act 408, content is scored. According to some embodiments, a computer system scores the relevancy of content for one or more documents. Acts in accord with these embodiments are discussed below with reference to FIG. 7.

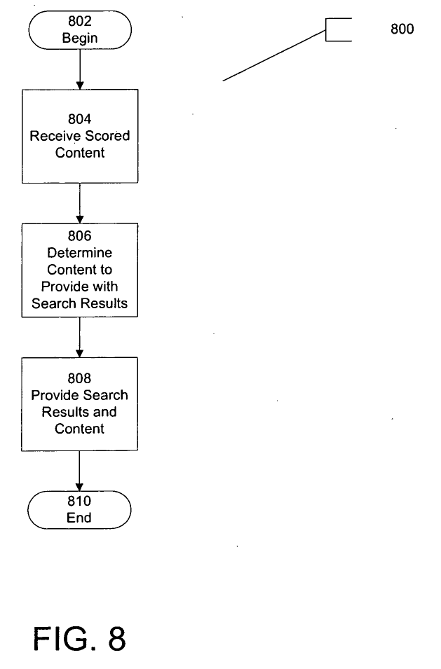

In act 410, content is provided. According to other embodiments, a computer system provides content in association with documents. Acts in accord with these embodiments are discussed below with reference to FIG. 8.

Process 400 ends at 412. Thus, process 400 enables a computer system to increase the automatically determine and display content that is representative of documents. By so doing, embodiments increase the communicative ability of document presentation systems, such as internet search engines.

Various embodiments provide processes for a computer system to process a query for documents. FIG. 5 illustrates one such process 500 that includes acts of providing a search interface, receiving a query and providing query information to a search engine. Process 500 begins at 502.

In act 504, a computer system provides a search interface to an external entity. According to one embodiment, the computer system presents the search interface 312 to a user. According to another embodiment the computer system exposes the search interface 312 to an external system.

In act 506, a computer system receives a query. In one embodiment, the query is received by the search interface 312 from a user. According to another embodiment, the query is received by the search interface from another system.

In act 508, a computer system provides the query to one or more search engines. For example, in one embodiment, the search interface 312 provides the query information to the search engine 328. As discussed above, the query information may include a variety of information, such as the text of the query and previous queries entered by the user.

Process 500 ends at 510.

Various embodiments provide processes for a computer system to determine search results based on query information. FIG. 6 illustrates one such process 600 that includes acts of providing query information to a vertical search engine, providing query information to a content search engine, receiving vertical search engine results and receiving content search engine results. Process 600 begins at 602.

In act 604, a computer system provides query information to a vertical search engine. For example, in one embodiment, the search engine 328 provides the query information to the vertical search engine 314. In this embodiment, the vertical search engine 314 determines, with reference to the content database 324, a set of results based on the provided query information.

In act 606, a computer system provides query information to a content search engine. For example, in one embodiment, the search engine 328 provides the query information to the content search engine 316. In this embodiment, the content search engine 316 determines, with reference to the content database 326, a set of results based on the provided query information.

In act 608, a computer system receives results from the vertical search engine 314. For example, in one embodiment, the search engine 328 receives results from the vertical search engine 314. In this embodiment, these results include document information regarding documents that match the query information.

In act 610, a computer system receives results from the content search engine 316. For example, in one embodiment, the search engine 328 receives results from the content search engine 316. In this embodiment, these results include content information regarding documents that match the query information.

Process 600 ends at 612.

Various embodiments provide processes for a computer system to score the relevancy of content relative to one or more documents. FIG. 7 illustrates one such process 700 that includes acts of providing vertical search results to a scoring engine, providing content search results to the scoring engine, providing query information to the scoring engine and scoring the relevancy of content to one or more documents. Process 700 begins at 702.

In act 704, a computer system provides vertical search results to a scoring engine. In one embodiment, the search engine 328 provides vertical search results to the scoring engine 318. As discussed above, these search results may include document information and content information for content that is associated with the document information.

In act 706, a computer system provides content search results to the scoring engine. In one embodiment, the search engine 328 provides content search results to the scoring engine 318. As discussed above, these search results may include content that is not associated with document information.

In act 708, a computer system provides query information to a scoring engine. In one embodiment, the search interface 312 provides query information to the scoring engine 318. As discussed above, the query information may include query text and other information related to the query, such as previous queries entered by a user.

In act 710, a computer system scores the relevancy of the content to the documents included in the vertical search results. For example, in one embodiment, the scoring engine 318 scores the relevancy of the content associated with the content information relative to the document information. As discussed above, the scoring engine 318 may use a variety of methods to compute this score. These methods may use, for example, the content information, the document information and the query information when determining a relevancy score.

Process 700 ends at 712.

Various embodiments provide processes for a computer system to provide content relevant to one or more documents. FIG. 8 illustrates one such process 800 that includes acts of receiving scored content, determining content to provide with search results and providing search results. Process 800 begins at 802.

In act 804, a computer system receives the scored content. For example, in one embodiment, the search engine 328 receives the scored content from the scoring engine 318. In this embodiment, the search engine 328 then provides the scored content to the selection engine 320.

In act 806, a computer system determines content to provide in association with search results. For example, in one embodiment, the selection engine 320 determines which content to include in the search results. As discussed above, the selection engine 320 may make this determination using a variety of information and techniques.

In act 808, a computer system provides the search results including the selected content. For example, in one embodiment the selection engine 320 provides the search results to the search engine 328. In this embodiment the search engine 328 then provides the search results to the search interface 312. As discussed above, the search interface 312 may present the document information included in the search results in association with any associated content.

Process 800 ends at 810.

Each of process 400, 500, 600, 700 and 800 depicts one particular sequence of acts in a particular embodiment. The acts included in each of these processes may be performed by, or using, one or more computer systems specially configured as discussed herein. Thus the acts may be conducted by external entities, such as users or separate computer systems, by internal elements of a system or by a combination of internal elements and external entities. Some acts are optional and, as such, may be omitted in accord with one or more embodiments. Additionally, the order of acts can be altered, or other acts can be added, without departing from the scope of the present invention. In at least some embodiments, the acts have direct, tangible and useful effects on one or more computer systems, such as storing data in a database or providing information to external entities.

Any reference to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements.

Any embodiment disclosed herein may be combined with any other embodiment, and references to “an embodiment,” “some embodiments,” “an alternate embodiment,” “various embodiments,” “one embodiment,” “at least one embodiment,” “this and other embodiments” or the like are not necessarily mutually exclusive and are intended to indicate that a particular feature, structure, or characteristic described in connection with the embodiment may be included in at least one embodiment. Such terms as used herein are not necessarily all referring to the same embodiment. Any embodiment may be combined with any other embodiment in any manner consistent with the aspects disclosed herein. References to “or” may be construed as inclusive so that any terms described using “or” may indicate any of a single, more than one, and all of the described terms.

Where technical features in the drawings, detailed description or any claim are followed by references signs, the reference signs have been included for the sole purpose of increasing the intelligibility of the drawings, detailed description, and claims. Accordingly, neither the reference signs nor their absence are intended to have any limiting effect on the scope of any claim elements.

Having now described some illustrative aspects of the invention, it should be apparent to those skilled in the art that the foregoing is merely illustrative and not limiting, having been presented by way of example only. Similarly, aspects of the present invention may be used to achieve other objectives including helping users to find content representative of documents that they have generated. Numerous modifications and other illustrative embodiments are within the scope of one of ordinary skill in the art and are contemplated as falling within the scope of the invention. For example, while the bulk of the illustrations used news article as documents, any sort of content may be used as the basis of the relevancy comparison. In particular, although many of the examples presented herein involve specific combinations of method acts or system elements, it should be understood that those acts and those elements may be combined in other ways to accomplish the same objectives.

What is claimed is:

1. A method for presenting search results, the method comprising:
receiving query information from an external entity;
determining first search results based at least in part on the query information, the first search results including document information relating to documents, the document information including content information referencing associated content that is associated with the documents; and
scoring the relevancy of the associated content relative to the documents to produce first scored content, the act of scoring being based at least in part on the query information and the first search results.

2. The method according to claim 1, wherein receiving the query includes receiving the query from a user.

3. The method according to claim 1, wherein determining first search results includes determining first search results using a vertical search engine.

4. The method according to claim 1, wherein scoring the content includes scoring the content using a parametric scoring function.

5. The method according to claim 1, wherein scoring the content includes scoring the content using a trained statistical model.

6. The method according to claim 1, further comprising:
determining second search results based at least in part on the query information and the first search results, the second search results including content information referencing unassociated content that is not associated with documents; and
scoring the relevancy of the unassociated content relative to the documents to produce second scored content, the act of scoring being based at least in part on the query information, the first search results and the second search results.

7. The method according to claim 6, wherein determining the second search results includes determining second search results using a content search engine.

8. The method according to claim 6, further comprising:
selecting display content from the first scored content and the second scored content based at least in part on the score of the first scored content and the score of the second scored content; and
providing the display content in association with the documents.

9. The method according to claim 8, wherein selecting display content includes selecting display content based at least in part on a parametric function.

10. The method according to claim 8, wherein selecting display content includes selecting display content based at least in part on a trained statistical model.

11. A system for presenting search results comprising:
a network interface;
a storage medium; and
a controller coupled to the network interface and the storage medium and configured to:
receive query information from an external entity;
determine first search results based at least in part on the query information, the first search results including document information relating to documents, the document information including content information referencing associated content that is associated with the documents; and
score the relevancy of the associated content relative to the documents to produce first scored content, the act of scoring being based at least in part on the query information and the first search results.

12. The system according to claim 11, wherein the controller is further configured to receiving the query from a user through a user interface.

13. The system according to claim 11, wherein the controller is further configured to determine first search results using a vertical search engine.

14. The system according to claim 11, wherein the controller is further configured to score the content using a parametric scoring function.

15. The system according to claim 11, wherein the controller is further configured to score the content using a trained statistical model.

16. The system according to claim 11, wherein the controller is further configured to:
determine second search results based at least in part on the query information and the first search results, the second search results including content information referencing unassociated content that is not associated with documents; and
score the relevancy of the unassociated content relative to the documents to produce second scored content, the act of scoring being based at least in part on the query information, the first search results and the second search results.

17. The system according to claim 16, wherein the controller is further configured to determine second search results using a content search engine.

18. The system according to claim 16, wherein the controller is further configured to:
select display content from the first scored content and the second scored content based at least in part on the score of the first scored content and the score of the second scored content; and
provide the display content in association with the documents.

19. The system according to claim 18, wherein the controller is further configured to select display content based at least in part on a parametric function.

20. The system according to claim 18, wherein the controller is further configured to select display content based at least in part on a trained statistical model.

21. The system according to claim 16, wherein the controller is further configured to:
determine appropriate content within the first scored content and the second scored content; and
select display content from the appropriate content based at least in part on the score of the appropriate content.
